(19) United States
(12) Patent Application Publication
(10) Pub. No.: US 2013/0043616 A1
(43) Pub. Date: Feb. 21, 2013

(54) DEVICE AND METHOD FOR PRODUCING PELLETS

(71) Applicant: AUTOMATIK PLASTICS MACHINERY GMBH, Grossostheim (DE)

(72) Inventor: Stefan Deiss, Harxheim (DE)

(73) Assignee: AUTOMATIK PLASTICS MACHINERY GMBH, Grossostheim (DE)

(21) Appl. No.: 13/657,451

(22) Filed: Oct. 22, 2012

Related U.S. Application Data
(63) Continuation of application No. PCT/EP2011/001984, filed on Apr. 19, 2011.

(30) Foreign Application Priority Data
Apr. 21, 2010 (DE) 102010015776.7
Apr. 19, 2011 (EP) PCT/EP2011/001984

(51) Int. Cl. B29B 9/00

(52) U.S. Cl. 264/142; 425/6

(57) ABSTRACT

A device and a method for producing pellets from a melt, having a perforated plate with melt nozzles located therein from which nozzles the melt emerges. The perforated plate is located opposite a cutter arrangement with a cutter head with at least one blade, and a cutter shaft driven by a motor so that the at least one blade passes over the melt nozzles in the perforated plate in a rotating manner and in doing so severs pellets of the melt material emerging there. The cutter shaft is at least axially displaceable relative to a process chamber housing by means of at least one adjustable bearing. The position of the at least one blade can be determined and adjusted using a position sensing and adjusting device.

### CROSS REFERENCE TO RELATED APPLICATIONS

The present patent application is a Continuation Application that claims priority to and the benefit of co-pending International Patent Application No. PCT/EP2011/001984, filed Apr. 19, 2011, entitled “DEVICE AND METHOD FOR PRODUCING PELLETS,” which claims priority to DE Application No. 102010015776.7 filed Apr. 21, 2010, entitled “DEVICE AND METHOD FOR PRODUCING PELLETS.” These references are incorporated in their entirety herein.

### FIELD

The present embodiments generally relate to a device and method for producing pellets from a melt.

### BACKGROUND

A need exists for a device and a method for producing pellets from a melt that makes possible, in a structurally simple manner, granulation that is automated while also being reliable and involving reduced wear.

A need exists for a device for producing pellets from a melt that has a long service life and that can achieve uniformly good quality of the granulation and of the resultant pellets.

The present embodiments meet these needs.

### BRIEF DESCRIPTION OF THE DRAWINGS

The detailed description will be better understood in conjunction with the accompanying drawings as follows:

FIG. 1 is a schematic of a longitudinal cross-sectional view of a section of a device for producing pellets according to a first preferred embodiment of the invention.

FIG. 2 is a schematic of a longitudinal cross-sectional view of a section of a device for producing pellets according to a second preferred embodiment of the invention.

FIG. 3 is a schematic of a partially cutaway view of a section of a device for producing pellets according to the first embodiment of the invention, viewed from the perforated plate.

FIG. 4 is a schematic of a partially cutaway view of a section of a device for producing pellets according to the second embodiment of the invention, viewed from the perforated plate.

The present embodiments are detailed below with reference to the listed Figures.

### DETAILED DESCRIPTION OF THE EMBODIMENTS

Before explaining the present device and method in detail, it is to be understood that the device and method are not limited to the particular embodiments and that they can be practiced or carried out in various ways.

The embodiments generally relate to a device and method for producing pellets from a melt. The device can have a perforated plate with melt nozzles located therein. The melt or plastic emerges from the melt nozzles.

A cutter arrangement with a cutter head can be located opposite the perforated plate. The cutter head can have at least one blade. A cutter shaft, driven by a motor, can be connected with the cutter head. The cutter head can be rotated by the cutter shaft so that the at least one blade can pass over the melt nozzles in the perforated plate. At least one blade can rotate in a circular manner. The at least one blade can sever the melt or plastic melt emerging from the melt nozzles into pellets of plastic material.

In this process, the at least one blade can pass over the melt nozzles of the perforated plate in the corresponding region either with or without making contact with the corresponding regions of the perforated plate.

The device can also include a process chamber housing that can connect to the perforated plate. The process chamber can surround at least a part of the cutter arrangement. For example, the process chamber can surround the cutter head and at least a section of the cutter shaft. A coolant can flow through the process chamber.

The cutter shaft can be at least axially displaceable relative to the process chamber housing by means of at least one adjustable bearing. The adjustable bearing can be located either in the region of the process chamber housing or in the region between the process chamber housing and the motor or a corresponding motor housing. The cutter shaft can be rotatable relative to the adjustable bearing.

The device can include a position sensing and adjusting device. The position sensing and adjusting device can have at least one position sensor. The at least one position sensor can be located in the process chamber housing, the perforated plate, or combinations thereof. The position sensing and adjusting device can also include at least one position sensor pulse transmitter. The at least one position sensor pulse transmitter can be located in the region of the cutter head. The at least one position sensor and the at least one position sensor pulse transmitter can determine the position of the at least one blade relative to the perforated plate with the melt nozzles located therein. The position sensing and adjusting device can also include an actuator device. The actuator device can adjust the position of the at least one blade depending on the determined positions of the at least one blade. The determined positions of the at least one blade using data sensed by the position sensing and adjusting device through the at least one position sensor and the at least one position sensor pulse transmitter. Consequently, the position of the at least one blade is not determined by a force measurement, but is instead determined by the position sensing and adjusting device.

The position sensing device can determine the position of the at least one blade of the cutter arrangement with respect to the perforated plate dynamically and/or in real time directly during operation of the device, and, on the basis of this determination of the corresponding positioning, an adjustment of the position can be carried out during operation by the adjusting device.

The position of the at least one blade can be set such that a certain gap is maintained between the at least one blade and the perforated plate and can be repeatedly adjusted as needed during operation without the necessity for contact of the blade on the perforated plate to take place.

Nonetheless, with the position sensing and adjusting device it is also possible to operate the granulating device with the at least one blade of the cutter arrangement being driven in a rotating manner in light contact with the perforated plate, which is to say preferably with no force. In any case, the result is a very flexible, and if desired, especially low-wear option for granulation with the device.

Flexible adjustability of the position of the at least one blade of the cutter arrangement relative to the perforated plate can be implemented by the means that the cutter shaft cannot only be axially movable relative to the process chamber housing by means of the at least one adjustable bearing, but can also be radially pivoted in space, on an appropriate spherical surface and the position of the at least one blade can be adjusted accordingly by means of the actuator device.

Thus, any angled positions that may be present between the cutter arrangement with the at least one blade and the perforated plate can be compensated easily in accordance with the invention. Hence increased forces (in sections) do not occur, which could otherwise arise between the cutter arrangement and the perforated plate in the event of a corresponding angled position of these elements relative to one another.

The at least one blade of the cutter arrangement can be adjustably arranged to rotate in a plane with constant distance from the perforated plate, wherein the distance can lie in a range from about 0.04 millimeter to about 0.3 millimeter depending on the material to be granulated. An optimal granulating action can be possible in a flexible manner depending on the material to be granulated, without the need for contact of the at least one blade of the cutter arrangement with the perforated plate, a feature which can also further reduce wear in an effective manner.

As already mentioned, based on the position sensing and adjusting device, it can also be possible to provide and make adjustable a plane of rotary motion of the at least one blade of the cutter arrangement, wherein the at least one blade is driven in a rotating manner without force but resting on the perforated plate.

To ensure simple positioning and position determination of the preferred position of the rotary motion of the cutter arrangement with respect to the perforated plate in a simple and reliable manner, the position sensor can be implemented in two parts, wherein a preferred plane can be defined in this process such that, in accordance with the orientation of the position sensor, this plane can be located between the first sensor part and the second sensor part in a plane that is parallel to the perforated plate, for example.

A simple and reliable determination of the position of the at least one blade of the cutter arrangement can also be provided by the means that the at least one position sensor pulse transmitter is located in the region of the at least one blade. The at least one position sensor pulse transmitter can be connected with the at least one blade. It can also be possible for a separate (individual) position sensor pulse transmitter to be located on each individual blade of a cutter arrangement having multiple blades. The arrangement and/or direct fastening to the individual blades can make reliable position sensing possible.

The cutter head can have a blade holder. The blade holder can secure the at least one blade to the cutter head in a replaceable manner. The at least one position sensor pulse transmitter can be located in the region of the blade holder. Consequently, the at least one position sensor does not have to be replaced if the at least one blade is changed. The at least one blade can be changed to accommodate a different material requiring a change in blade type and cutter geometry or when the wear limit of the at least one blade is reached.

The at least one position sensor can also be located in the region of the perforated plate. For example, the at least one position sensor can be located in the region of the perforated plate radially inward of the melt nozzle, which are preferably arranged in a circle. This can permit simple axial alignment of the at least one blade of the cutter head with respect to the perforated plate.

The at least one position sensor can also be located in the region of the process chamber housing. This can permit the alignment of the plane of rotation of the at least one blade of the cutter arrangement with respect to the perforated plate in a simple manner, since a plane of the circulating rotary motion of the cutter arrangement or of the at least one blade of the cutter arrangement can be defined in a simple manner just by means of a position sensor located in the region of the process chamber housing radially outward from the rotary motion of the cutter arrangement.

The position of the cutter arrangement or of the at least one blade of the cutter arrangement relative to the perforated plate in a reliable manner, an angular position sensor can be associated with the motor shaft or the cutter arrangement in addition to the at least one position sensor pulse transmitter.

It is thus possible, even with an angled position of the plane of the rotary motion of the at least one blade in the region of the cutter head of the cutter arrangement, to ensure sensing of the angled position and hence additionally design the corresponding adjustability of the parallelism of the plane of this motion relative to the perforated plate in a simple manner.

The position sensing device of a device for producing pellets from a melt can be designed such that the position sensor and the at least one position sensor pulse transmitter are designed such that they form an optical laser position sensing system. In this design, the position sensor can be implemented as a laser or as laser optics, and the position sensor pulse transmitter as a reflective surface that returns appropriate laser rays to the position sensor with a sensing device.

The position sensor and the at least one position sensor pulse transmitter can be designed such that they form an inductive position sensing system. This can be of advantages when, for example, an optical system could not function satisfactorily through an appropriate spatial arrangement due to interfering pellets. It is also possible in useful fashion for the position sensor and the at least one position sensor pulse transmitter to be designed such that they form a capacitive position sensing system.

In order to make it possible to reliably determine the plane of motion of the at least one blade in the region of the cutter head of the cutter arrangement, or the plane of motion of the cutter arrangement, at least three position sensor pulse transmitters can be provided. These three position sensor pulse transmitters uniquely define a corresponding plane through their position.

In order to make positioning easier and, in accordance with the invention, to simplify alignment by the position adjusting device based on the signals from the position sensing device, the at least three position sensor pulse transmitters can each be individually encoded. By this means, an angled position of the plane of rotary motion of the at least one blade of the cutter head of the cutter arrangement can be implemented.

The actuator device of the position sensing and adjusting device can have a variable speed drive. The variable speed drive can be a two-axis variable speed drive. The variable speed drive can be with fine-pitch gear racks or a spur gear drive.

The axes of the variable speed drive can be perpendicular to one another, so that adjustment in the axial direction and/or in the radial direction can be correspondingly possible.

The actuator device can be located on a section of the process chamber housing that can be located opposite the region of the perforate plate at a distance, and the actuator device can also be located between the motor or the motor housing and the process chamber housing.

In order to further increase the stability of the cutter arrangement with regard to the position to be set relative to the perforated plate and minimize possible twisting and bending stresses in operation in the device for producing pellets from a melt, the cutter shaft can also be supported by a cutter shaft mount in at least one region thereof, such as in a region thereof facing the perforated plate. The region facing the perforated plate can be up to about 30 percent of the length of the cutter shaft.

The adjustable bearing can be located between an end region of the process chamber housing and the cutter shaft mount. In this design, the adjustability by means of the adjusting device with the corresponding actuator device can be located between the process chamber housing, or an appropriate section thereof, and the cutter shaft mount.

In order to achieve simple adjustment of the parallelism of the plane of rotary motion of the cutter head with the at least one blade of the cutter arrangement with respect to the perforated plate, for example in the event of maintenance or at initial assembly of the device according to the invention, a dressing contact surface for dressing the at least one blade in case of contact of the at least one blade on the dressing contact surface can be provided in the region of the perforated plate, wherein the perforated plate itself can be designed as such dressing contact surface, or at least a part of the perforated plate can be designed as such dressing contact surface. In this design, the dressing contact surface preferably can be designed to be annular in the region that is swept in a rotary manner by the at least one blade of the cutter arrangement.

The device for producing pellets from a melt can be used in a flexible manner to produce pellets if the device, as a whole, can be suspended from a slide rail by means of a suspension and can be axially movable, wherein the suspension can be provided on a housing of the motor and/or on the process chamber housing.

In the process for producing pellets from a melt, the melt can emerge from melt nozzles located in a perforated plate into a process chamber housing. The process chamber housing in the device for producing pellets from a melt adjoins the perforated plate and surrounds at least a part of a cutter arrangement having a cutter head with at least one blade and a cutter shaft, driven by a motor, located opposite the perforated plate.

Pellets can be severed from the melt emerging from the melt nozzles by the rotating blade of the cutter arrangement. In the method, the cutter shaft can be supported so as to be at least axially displaceable relative to the process chamber housing by means of at least one adjustable bearing, and a position sensing and adjusting device can be provided, with at least one position sensor located in the process chamber housing and/or the perforated plate, and with at least one position sensor pulse transmitter, located in the region of the cutter head, by means of which the position of the at least one blade is determined relative to the perforated plate with the melt nozzles located therein, and with an actuator device by means of which the position of the at least one blade is set according to the values determined by the position sensing and adjusting device.

Thus, in a simple manner, a positioning of the plane of motion of the at least one rotating blade of the cutter arrangement with respect to the perforated plate is possible by the position determination and corresponding adjustment between an actual position and a target position with appropriate tracking motion, by which means the granulating process is also simple to control and the quality of the pellets can be improved. The wear of the perforated plate and of the at least one blade of the cutter arrangement can thus also be reduced in a simple manner, since it is not necessary for relatively large forces to arise between the at least one blade of the cutter arrangement and the perforated plate, as is otherwise absolutely necessary with the force measurement between blade and perforated plate according to the prior art.

The method can include allowing the cutter shaft to pivot radially in space, for example on a suitable spherical surface, relative to the process chamber housing by means of the at least one adjustable bearing, and the position of the at least one blade is appropriately adjusted by means of the actuator device.

The at least one blade can be adjustably arranged to rotate in a plane with constant distance from the perforated plate. The distance from the perforated plate can be from about 0.04 millimeter to about 0.3 millimeter. The distance from the perforated plate can depend on the material to be granulated and the other granulating conditions, such as temperature of the melt, viscosity of the melt, pressure of the process fluid in the process chamber, etc.

Thus, for example, the distance from the perforated plate can be set to be smaller for granulating low-viscosity plastic material than for granulating plastic material with higher viscosity or with plastic material that contains additional fillers.

The method can be carried out such that the alignment of the position of the at least one blade or the corresponding cutter arrangement in a plane in the direction of rotation parallel to the perforated plate takes place first, and subsequently, depending on the situation sensed, only an axial adjustment, an axial adjustment to a predefined spacing of the plane from the perforated plate, takes place. This is especially simple because the parallel alignment can be performed even before the actual normal operation of the device, and then only a simpler axial adjustment of the position of the plane of motion of the at least one blade, which is already aligned parallel, relative to the perforated plate must take place in operation without the need for an additional pivoting motion; however, the latter can also be possible as described above.

In the case of the parallel alignment of the position of the at least one blade in a plane in the direction of rotation parallel to the perforated plate, which can be carried out first, can be performed in such a way that the cutter head with the at least one blade is first moved up to the perforated plate, and is suitably aligned there either by pivoting or by dressing of the at least one blade at a dressing contact surface of the perforated plate.

Position adjustment during operation can be carried out with the method such that the position of the at least one blade is set in an oscillating manner, for example, in a type of pendulum motion between two positions, preferably oscillating in the axial direction between a first end position closer to the perforated plate and a second end position further from the perforated plate. Such an oscillating back-and-forth motion is simple to control and permits simple positioning. In this design, the end positions can be from about 0.04 millimeter to about 0.3 millimeter away from one another in the axial direction, for example.

The features and characteristics described in connection with the method according to the invention are also valid, to the degree applicable, to the device according to the invention and vice versa.

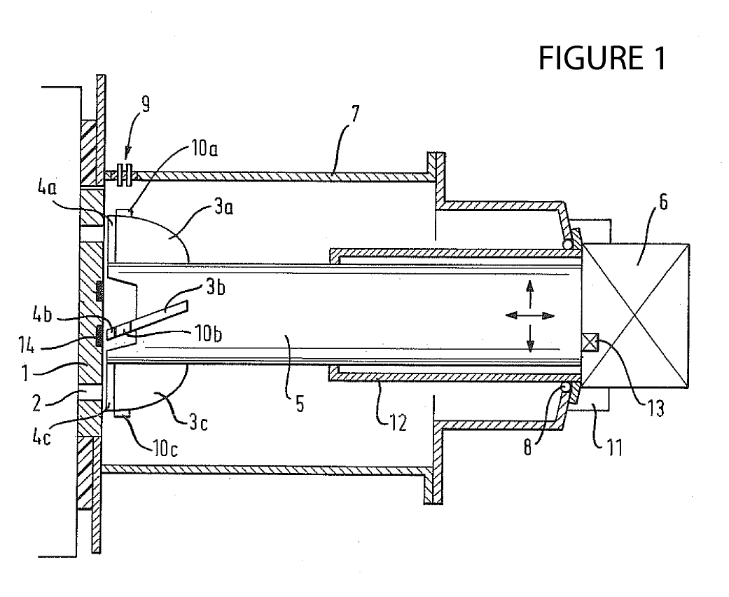

Turning now to the Figures, FIG. 1 shows in a schematic longitudinal cross-section, a section of a device for producing pellets from a melt, preferably a plastic melt.

The device can have a perforated plate 1 with melt nozzles 2 located therein, which can be arranged in a circle. The melt emerges from the melt nozzles 2.

A cutter arrangement with a cutter head with at least one blade, in the case of the embodiment shown with four blades 4a, 4b, 4c, and 4d (position 4d is not visible in FIG. 1), attached to blade holders 3a, 3b, 3c, and 3d (position 3d is not visible in FIG. 1) of the cutter head, and a cutter shaft 5 driven by a motor 6, is located opposite the perforated plate 1, so that the blades 4a, 4b, 4c, and 4d pass over the melt nozzles 2 in the perforated plate 1 in a rotating manner and in doing so severs pellets from the melt emerging from the melt nozzles.

The device can have a process chamber housing 7. The process chamber housing 7 can connect with the perforated plate 1 and, as shown in FIG. 1, can have an additional section in the rear region which is adjoined by the motor 6. The motor 6 can have a housing. The housing and motor 6 can adjoin the rear region of the process chamber housing 7. The process chamber housing 7 in this design can surround at least a part of the cutter arrangement and has a coolant flowing through it.

At least one adjustable bearing 8 can be provided by means of which the cutter shaft 5 is at least axially displaceable relative to the process chamber housing 7. The adjustable bearing 8 can be arranged as a ball bearing that rotates in a circular fashion, for example in the rear section of the process chamber housing 7, facing away from the region of the perforated plate 1, as is shown in FIG. 1.

As is also shown in FIG. 1, the cutter shaft 5 can also be radially pivoted relative to the process chamber housing 7 by means of the at least one adjustable bearing 8. The adjustment options by means of the adjustable bearing 8 are indicated by the arrows in FIG. 1.

In the embodiment of FIG. 1, the cutter shaft 5 can be additionally supported by a cutter shaft mount 12, wherein the cutter shaft mount 12 can support the cutter shaft 5 in a front region facing the perforated plate 1. In this case, the cutter shaft mount 12 is suitably implemented as an additional sleeve. The cutter shaft mount 12 in the embodiment in FIG. 1 is not designed to be rotatable relative to the process chamber housing 7.

An embodiment is also conceivable in which the additional cutter shaft mount 12 can also be made rotatable relative to the process chamber housing 7, but not relative to the cutter shaft 5. The cutter shaft mount 12 in this case can also be a part of the positioning device, so that a displacement of the cutter shaft 5 in the axial direction relative to the cutter shaft mount 12, which is provided as rotationally fixed or rotatable with the cutter shaft 5, can then take place, for example.

A position sensing and adjusting device with a position sensor 9 located in the process chamber housing 7, and position sensor pulse transmitters 10a, 10b, 10c, and 10d (position 10d is not visible in FIG. 1), located in the region of the cutter head.

As shown in FIG. 1, the sensor pulse transmitters 10a, 10b, 10c, and 10d can be located on blade holders 3a, 3b, 3c, and 3d. The blade holders 3a, 3b, 3c, and 3d can hold the blades 4a, 4b, 4c, and 4d. The position sensor 9 is designed as a two-part position sensor 9 and thus defines a target position plane extending parallel to the perforated plate 1 between the two sensor parts.

The position of the blades 4a, 4b, 4c, and 4d relative to the perforated plate 1 can be determined by means of the position sensor 9 and the position sensor pulse transmitters 10a, 10b, 10c, and 10d.

The position of the blades can be adjusted by an actuator device 11, the position of the blades 4a, 4b, 4c, and 4d in a plane parallel to the plane of the perforated plate 1 can accordingly be regulated and adjusted as a function of the values determined by the position sensing device in a comparison between the target value and the actual value.

The actuator device 11 can be a variable speed drive, which can be located in the region of the process chamber housing 7 facing away from the perforated plate 1 in the region between the process chamber housing 7 and the motor 6 or the housing of the motor 6. To simplify the position determination, an angular position sensor 13, which preferably can be associated with the cutter shaft 5, can additionally be provided, as is shown in FIG. 1.

A dressing contact surface 14, which can be arranged for circular rotation, can be located in the region of the perforated plate 1 for dressing the blades 4a, 4b, 4c, and 4d on this dressing contact surface 14. This dressing contact surface 14 can be made of especially hard material, for example corundum material, or can be provided by a coating provided there on the perforated plate 1.

Thus, the alignment of the position of the blades 4a, 4b, 4c, and 4d in a plane in the circumferential direction parallel to the perforated plate 1 can be performed in such a manner that the cutter head with the blades is first moved to the perforated plate, and is aligned there by suitably dressing the blades on the dressing contact surface 14 of the perforated plate 1. An appropriate pivoting would be possible in this regard as well.

In the operating state of the device shown in FIG. 1, the spacing of the plane of rotation of the blades from the perforated plate 1 can be held in a range from about 0.04 millimeter to about 0.3 millimeter, for example, depending on the material to be granulated. Thus, an exact positioning accordingly takes place without the need for the blades to touch the perforated plate 1 in operation, and thus without the occurrence of a wear-producing contact pressure between blade and perforated plate 1.

Hereinafter, identical reference symbols are used in the additional figures to designate the same elements of the invention. To the extent applicable, the statements made with reference to particular figures and particular elements apply correspondingly to the other figures as well.

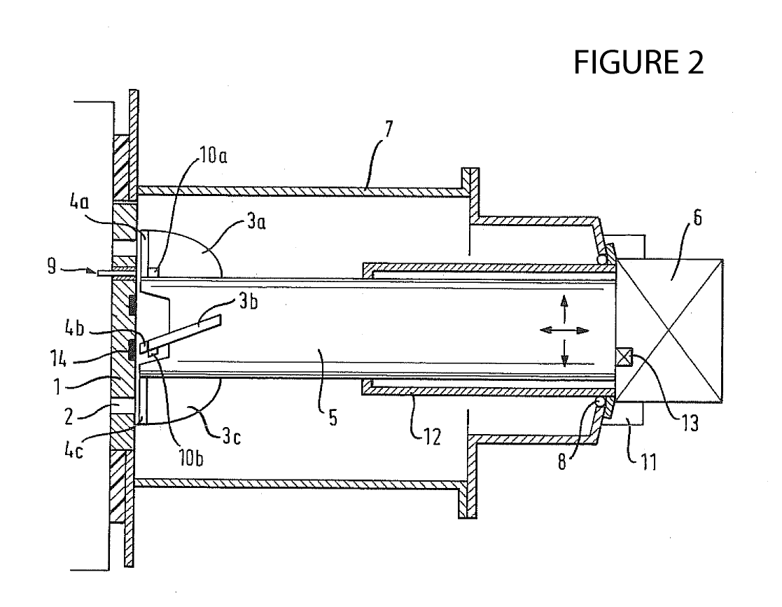

FIG. 2 shows a schematic, longitudinal cross-sectional view of a section of a device for producing pellets.

The embodiment according to FIG. 2 differs from the embodiment according to FIG. 1 in that the position sensor 9 is of single-piece design and is located in the region of the perforated plate 1, wherein according to the embodiment in FIG. 2 the position sensor 9 is located radially inward of the melt nozzles 2 of the perforated plate 1, which are arranged in a circle. The embodiment according to FIG. 2 otherwise corresponds to the embodiment shown in FIG. 1.

In both the embodiment according to FIG. 1 and the embodiment according to FIG. 2, the position sensor pulse transmitters 10a, 10b, 10c, and 10d are each attached to the blade holders 3a, 3b, 3c, and 3d of the cutter head.

The embodiment according to FIG. 2 differs in this regard from the embodiment according to FIG. 1 solely in that the arrangement of the position sensor pulse transmitters is in each case located in the region closer to the cutter shaft corresponding to the position of the position sensor 9 located opposite in the perforated plate 1, whereas in contrast, in the embodiment according to FIG. 1 the position sensor pulse transmitters are each located in the radially outer region of the blade holder closer to the position sensor 9 located in the process chamber housing 7.

The position sensor 9 and the position sensor pulse transmitters 10a, 10b, 10c, and 10d according to the illustrations in FIG. 1 and FIG. 2 can be designed such that they form an optical laser position sensing system. They can also be designed such that they form an inductive position sensing system. They can also be designed such that they form a capacitive position sensing system.

FIG. 2 also depicts the blades 4a, 4b, and 4c, the melt nozzles 2, dressing contact surface 14, the cutter shaft 5, the motor 6, the actuator device 11, the adjustable bearing 8, the angular position sensor 13, and the cutter shaft mount 12.

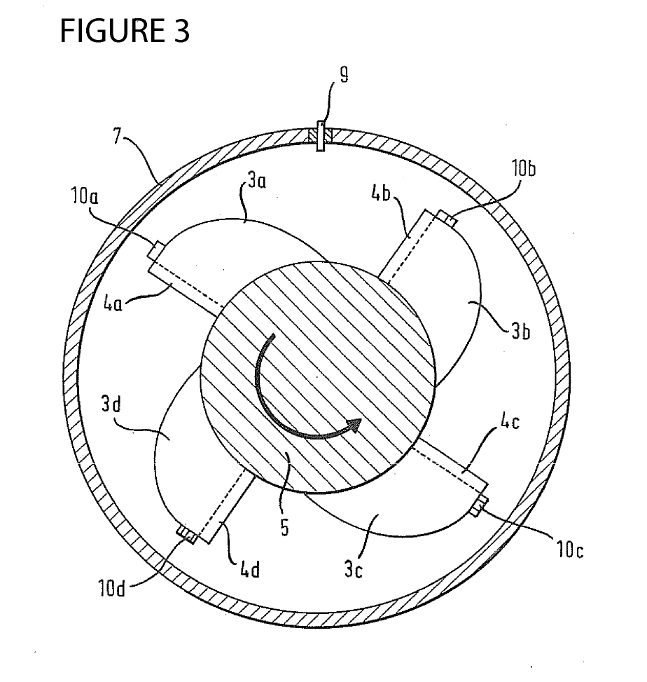

FIG. 3 schematically shows a partially cutaway view of a section of a device for producing pellets according to the first embodiment, viewed from the perforated plate. In this regard, please refer to the corresponding illustration of the first embodiment from FIG. 1.

As evident in FIG. 3, the position sensor 9 is embedded in the process chamber housing 7, and the position sensor pulse transmitters 10a, 10b, 10c, and 10d are each attached to respective blade holders 3a, 3b, 3c, and 3d. The blade holders 3a, 3b, 3c, and 3d connect the blades 4a, 4b, 4c, and 4d in a replaceable manner with the cutter shaft 5. As is indicated in FIG. 3, the respective position sensor pulse transmitters 10a, 10b, 10c, and 10d are each individually encoded (single, double, triple, quadruple). In this way, individual position sensing is possible and thus precise determination of the location of the plane of rotary motion of the cutter head of the corresponding cutter arrangement.

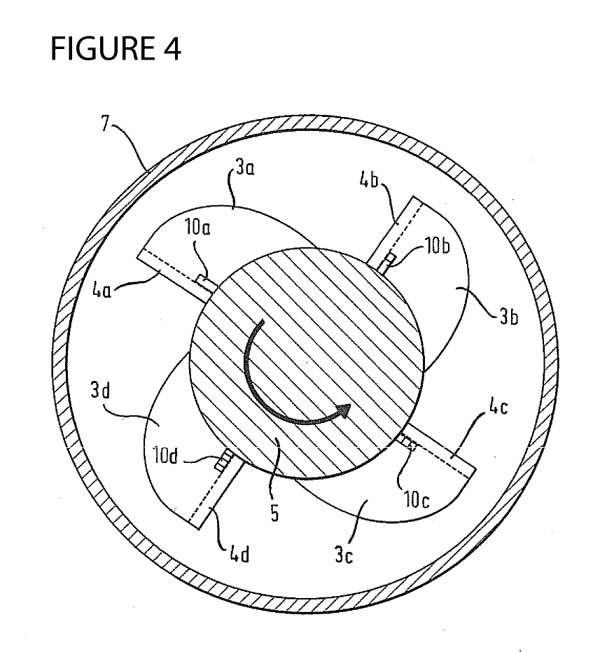

FIG. 4 schematically shows a partially cutaway view of a section of a device for producing pellets according to the second embodiment of the invention, viewed from the perforated plate.

The illustration according to FIG. 4 differs from the illustration according to FIG. 3 solely in that according to the illustration in FIG. 4, the position sensor pulse transmitters 10a, 10b, 10c, and 10d are located closer to the cutter shaft 5, since in this embodiment the respective position sensor pulse transmitters work together with the position sensor located in the perforated plate. In this regard, please refer to the corresponding illustration of the second embodiment of FIG. 2.

FIG. 4 also depicts the blade holders 3a, 3b, 3c, and 3d, the process chamber housing 7, and the blades 4a, 4b, 4c, and 4d.

While these embodiments have been described with emphasis on the embodiments, it should be understood that within the scope of the appended claims, the embodiments might be practiced other than as specifically described herein.

What is claimed is:

1. A device for producing pellets from a melt comprising:
a. a perforated plate with melt nozzles located therein from which the melt emerges;
b. a cutter arrangement located opposite the perforated plate, wherein the cutter arrangement comprises:
(i) a cutter head with at least one blade; and
(ii) a cutter shaft driven by a motor so that the at least one blade passes over the melt nozzles in the perforated plate in a rotating manner and in doing so severs pellets of the melt emerging there;
c. a process chamber housing connected with the perforated plate, wherein the process chamber housing surrounds at least a part of the cutter arrangement, and wherein a coolant flows through the process chamber housing;
d. at least one adjustable bearing configured to make the cutter shaft at least axially displaceable relative to the process chamber housing;
e. a position sensing and adjusting device comprising:
(i) at least one position sensor located in the process chamber housing, the perforated plate, or both;
(ii) at least one position sensor pulse transmitter located in a region of the cutter head, wherein the position of the at least one blade relative to the perforated plate is determined by the at least one position sensor and the at least one position sensor pulse transmitter; and
(iii) an actuator device configured to adjust the position of the at least one blade.

2. The device of claim 1, wherein the at least one adjustable bearing is configured to radially pivot the cutter shaft relative to the process chamber housing, and wherein the actuator device is configured to adjust the position of the at least one blade accordingly.

3. The device of claim 1, wherein the at least one blade is adjustably arranged to rotate in a plane with constant distance from the perforated plate, wherein the constant distance is from 0.04 millimeter to 0.3 millimeter.

4. The device of claim 1, wherein the at least one position sensor is designed as two parts.

5. The device of claim 1, wherein the at least one position sensor pulse transmitter is located in a region of the at least one blade.

6. The device of claim 1, further comprising a blade holder on the cutter head, wherein the blade holder holds the at least one blade thereon in a replaceable manner, and wherein the at least one position sensor pulse transmitter is connected with the blade holder.

7. The device of claim 1, wherein the at least one position sensor is located in a region of the perforated plate radially inward of the melt nozzles.

8. The device of claim 1, wherein the at least one position sensor is located in a region of the process chamber housing.

9. The device of claim 1, further comprising an angular position sensor associated with a motor shaft.

10. The device of claim 1, wherein the at least one position sensor and the at least one position sensor pulse transmitter are designed such that they form an optical laser position sensing system, an inductive position sensing system, or a capacitive position sensing system.

11. The device of claim 1, wherein the at least one position sensor pulse transmitter comprises at least three position sensor pulse transmitters.

12. The device of claim 11, wherein the at least three position sensor pulse transmitters are each individually encoded.

13. The device of claim 1, wherein the actuator device has a variable speed drive, wherein the variable speed drive is a two-axis variable speed drive with a fine-pitch gear rack(s) drive or a spur gear drive.

14. The device of claim 1, wherein the region of the cutter shaft facing the perforated plate and up to 30 percent of the length of the cutter shaft is supported by a cutter shaft mount.

15. The device of claim 14, wherein the adjustable bearing is located between an end region of the process chamber housing and the cutter shaft mount.

16. The device of claim 1, further comprising a dressing contact surface for dressing the at least one blade in the case of contact of the at least one blade on the dressing contact surface in the region of the perforated plate.

17. The device of claim 1, wherein the device as a whole is suspended from a slide rail by a suspension and is axially movable, wherein the suspension is provided on a housing of the motor, the process chamber housing, or both.

18. A method for producing pellets from a melt, wherein the melt emerges from melt nozzles located in a perforated plate in a process chamber housing that connects to the perforated plate and surrounds at least a part of a cutter arrangement and is passed through by a coolant, and in doing so pellets are severed by the cutter arrangement with a cutter head with at least one blade and a cutter shaft driven by a motor located opposite the perforated plate, wherein the cutter shaft is at least axially displaceable relative to the process chamber housing by means of at least one adjustable bearing, and wherein a position sensing and adjusting device with at least one position sensor located in the process chamber housing and/or in the perforated plate, and at least one position sensor pulse transmitter located in a region of the cutter head, by means of which the position of the at least one blade is determined relative to the perforated plate with the melt nozzles located therein, and with an actuator device by means of which the position of the at least one blade is adjusted accordingly.

19. The method of claim 18, further comprising aligning the at least one blade by axially adjusting the position of the at least one blade in a plane in the direction of rotation parallel to the perforated plate first, and subsequently, depending on the situation sensed, to a predefined spacing of the plane from the perforated plate, and wherein alignment of the position of the at least one blade in a plane in the direction of rotation parallel to the perforated plate comprises first moving the cutter head with the at least one blade up to the perforated plate and aligning the at least one blade either by pivoting or by dressing of the at least one blade at a dressing contact surface of the perforated plate.

20. The method of claim 18, wherein the position of the at least one blade is set in an oscillating manner between two positions, preferably oscillating in the axial direction between a first end position closer to the perforated plate and a second end position further from the perforated plate.
